(19) United States
(12) Patent Application Publication
(10) Pub. No.: US 2023/0021828 A1
(43) Pub. Date: Jan. 26, 2023

(54) MAINTENANCE SUPPORT SYSTEM

(71) Applicant: Hitachi, Ltd., Tokyo (JP)

(72) Inventors: Noriyasu HASEJIMA, Tokyo (JP); Kazuya MUROTANI, Tokyo (JP); Yuichi IGARASHI, Tokyo (JP); Yuta ESAKA, Tokyo (JP)

(21) Appl. No.: 17/751,728

(22) Filed: May 24, 2022

(30) Foreign Application Priority Data
Jul. 21, 2021 (JP) 2021-120475

(51) Int. Cl. G05D 1/02; G06T 7/00

(52) U.S. Cl. CPC G05D 1/0274; G06T 7/0004; G06T 2207/30108; G05D 2201/0207

(57) ABSTRACT

A worker constructs a map necessary for inspection of infrastructure equipment using data acquired using a target imaging device as data necessary for map generation, thereby reducing the cost necessary for transportation and the like of an autonomous inspection apparatus, and moreover, travel evaluation and inspection evaluation are performed using an evaluation function, and a map necessary for the inspection can be corrected based on a travel route of an autonomous travel route and an inspection result based on an evaluation result, whereby the introduction cost can be reduced.

### CLAIM OF PRIORITY

The present application claims priority from Japanese Patent Application JP 2021-120475 filed on Jul. 21, 2021, the content of which are hereby incorporated by references into this application.

### BACKGROUND OF THE INVENTION

### 1. Field of the Invention

The present invention relates to a technique for supporting maintenance of equipment. The present invention relates in particular to evaluation of a route in maintenance of equipment.

The equipment includes so-called infrastructure equipment such as instruments, equipment, factories, and plants. The maintenance includes inspection, examination, and repair.

### 2. Description of the Related Art

In recent years, with decrease in population and super-aging, decrease in working population, which is the main actor of economic activities, has become a social problem, and there is a problem of shortage of examiner in maintenance of equipment represented by inspection of infrastructure equipment. In inspection of infrastructure equipment, an examiner visually checks a predetermined meter or the like, and examination results may vary depending on the skill of examiners. The examination range in infrastructure equipment sometimes spans several kilometers or more in a large place, often leading to a physical burden on the examiner.

Under such circumstances, there has been an active trend of use of autonomous traveling robots as alternative labor force, and among them, application of autonomous mobile robots has progressed due to cost reduction of sensors and advancement of calculation apparatuses. For example, a technique as described in JP 2015-161577 A below has been proposed.

JP 2015-161577 A presents an example related to provision of a self-traveling inspection device for the purpose of inspection work for production equipment in the manufacturing industry.

### SUMMARY OF THE INVENTION

In order to implement the technique presented in JP 2015-161577 A, a map necessary for estimating the position of a moving body (vehicle) such as an autonomous inspection apparatus with high accuracy and a map recording an inspection target are required. However, in a case where these maps are created using a moving body, there is a problem of introduction cost to a facility, including time and effort for transporting the moving body and evaluation using the constructed moving body.

The present invention has been made in view of the above points, and an object thereof is to support maintenance by more easily evaluating workability of maintenance.

In order to solve the above problem, the present invention evaluates workability including whether to be capable of maintenance work for a round plan including a travel route. More specifically, a maintenance support system that supports maintenance using a moving body for equipment includes: a map generation unit that generates a map of the equipment; a travel route generation unit that generates a travel route of the moving body for the maintenance; a maintenance target setting unit that sets a maintenance target of maintenance to be executed along the travel route having been generated; an evaluation unit that evaluates whether to be capable of maintenance work that follows maintenance information including the travel route and the maintenance target and indicating a round plan of the moving body; and a maintenance information correction unit that corrects the maintenance information according to a result of the evaluation.

The present invention also includes each apparatus constituting the maintenance support system, sub-combination thereof, and a method using the same. Furthermore, the present invention also includes a program that causes the maintenance support system, each apparatus constituting the maintenance support system, and sub-combination thereof to function as a computer, and a storage medium storing the program.

According to the present invention, it is possible to more easily evaluate workability of maintenance work using a moving body. For example, it is possible to reduce introduction cost of a maintenance system. Problems and effects other than those described above will be made clear by the following description of the embodiment.

### BRIEF DESCRIPTION OF THE DRAWINGS

FIG. 1 is a functional block diagram of a target imaging device and a virtual simulation apparatus in Example 1;

FIG. 2 is a hardware configuration diagram of the virtual simulation apparatus in Example 1;

FIG. 3A is a diagram schematically illustrating a map stored in an inspection site DB in Examples 1 and 2;

FIG. 3B is a diagram illustrating acquisition information and simulation results stored in the inspection site DB in Examples 1 and 2;

FIG. 4 is a flowchart illustrating a process flow of a simulation function in Example 1;

FIG. 5 is a flowchart illustrating details of a process flow of virtual autonomous travel in Example 1;

FIG. 6 is a functional block diagram of a target imaging device, an inspection information management apparatus, and an autonomous inspection apparatus in Example 2; and

FIG. 7 is a flowchart illustrating a process flow of a test run function in Example 2.

### DESCRIPTION OF THE PREFERRED EMBODIMENTS

An embodiment of the present invention will be described below with reference to the drawings. In the present embodiment, an inspection support system that is a type of maintenance support system is used to evaluate an inspection plan that is a type of maintenance plan. Therefore, a case where an inspection is performed as maintenance will be described as an example. An autonomous inspection apparatus 600 (robot) will be described as an example of a moving body that performs maintenance. In the present embodiment, the place where inspection is performed is referred to as “inspection site” for convenience. For the above reason, the term “inspection” in each example can include “maintenance” more broadly.

Here, equipment such as infrastructures has often been used for many years, called legacy. In such equipment, it is difficult to automatically collect operation information and collectively inspect the equipment in a center system or the like. This is because there is necessity to newly construct an inspection system such as a sensor and a network, and there are problems in terms of cost and labor.

Therefore, it is necessary to appropriately check an inspection target such as an existing meter. Therefore, in the present embodiment, the autonomous inspection apparatus 600, which is a type of robot, performs inspection such as meter reading. That is, in the present embodiment, a map and inspection information necessary for the autonomous inspection apparatus 600, which is a type of maintenance device, to perform inspection are generated based on information acquired in advance based on a target imaging device. Then, the inspection plan is evaluated by performing virtual or test inspection work in the autonomous inspection apparatus 600 using these. Examples, which are more specific examples of the present embodiment, will be described below.

### Example 1

As an inspection support system, Example 1 uses a virtual simulation apparatus 200, which is a type of maintenance support apparatus. That is, the inspection plan is evaluated based on a simulation result of the virtual simulation apparatus 200. Hereinafter, the details will be described in the order of configuration, information, and process flow.

### <Configuration>

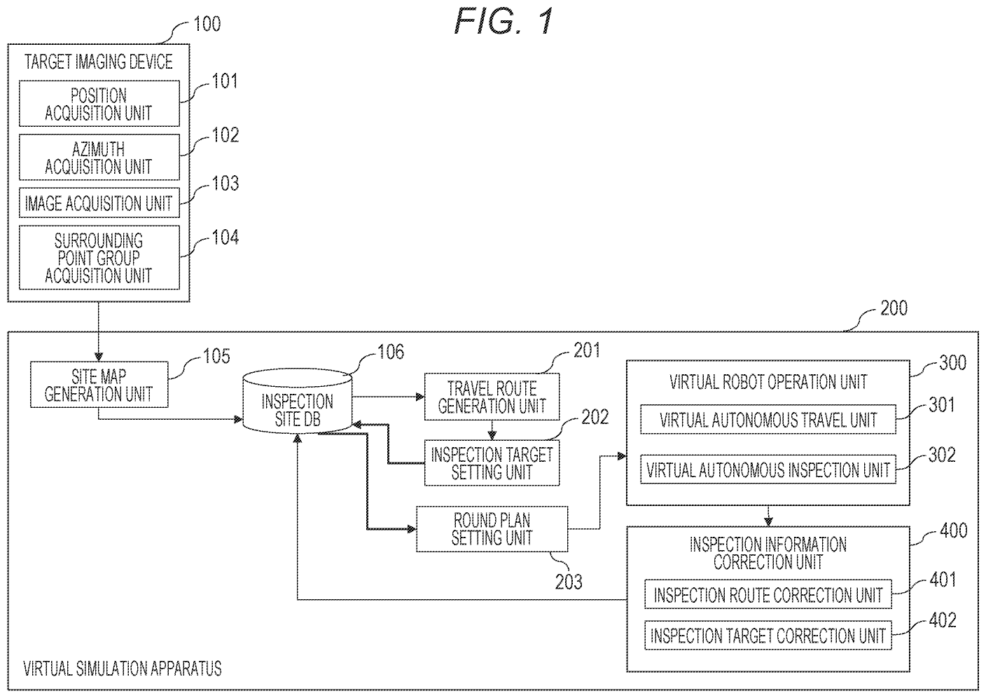

First, FIG. 1 is a functional block diagram of a target imaging device 100 and the virtual simulation apparatus 200 in Example 1.

First, the target imaging device 100 can be implemented by a camera or the like, and has a function of acquiring information necessary for creation of a map, such as an imaging function. In the present example, the target imaging device 100 images the inside of an inspection site in order to create a map used for inspection. For this purpose, the target imaging device 100 includes a position acquisition unit 101, an azimuth acquisition unit 102, an image acquisition unit 103, and a surrounding point group acquisition unit 104.

First, the position acquisition unit 101 acquires the position of the target imaging device 100. Therefore, the position acquisition unit 101 is desirably a sensor that estimates the position of the target imaging device 100 at, for example, 5 cm or less by combining a global navigation satellite system (GNSS), an inertial measurement unit (IMU), and the like. When the target imaging device 100 is provided in the autonomous inspection apparatus 600, the position of the autonomous inspection apparatus 600 is acquired.

The position acquisition unit 101 may estimate the position of the target imaging device 100 or the autonomous inspection apparatus 600 by simultaneous localization and mapping (SLAM) using the acquisition results of the image acquisition unit 103 and the surrounding point group acquisition unit 104. In this case, those positions are expressed as a relative relationship from the origin position described with the absolute coordinates.

The azimuth acquisition unit 102 acquires the direction in which the target imaging device 100 is oriented. For this reason, the above-described IMU can be used as the azimuth acquisition unit 102. As the IMU used here, it is also possible to use a sensor capable of calculating an absolute azimuth, such as an electronic compass, in addition to a sensor that senses a relative azimuth, such as a fiber optic gyro (FOG) in combination. The azimuth acquisition unit 102 can further improve accuracy by using an acceleration sensor in addition to the FOG and the electronic compass.

The image acquisition unit 103 acquires an image around the target imaging device 100. Therefore, the image acquisition unit 103 can be implemented by a so-called optical system such as a lens or an imaging element. In particular, the image acquisition unit 103 can desirably acquire an image of 360 degrees around the target imaging device 100. The image acquisition unit 103 may be implemented by one camera independent of the target imaging device 100 or a plurality of cameras capable of acquiring narrow angle images. Although information on the entire circumference of 360 degrees is acquired here, the acquisition range of the image is not limited to 360 degrees in the present example. However, for the imaging direction of the image acquisition unit 103, the relationship with the azimuth acquisition unit 102 described above needs to be known. In the case of using the plurality of cameras, it is more desirable that the geometric relationship among the cameras is calibrated.

The surrounding point group acquisition unit 104 acquires the surrounding environment of the target imaging device 100 as a three-dimensional point group. That is, the surrounding point group acquisition unit 104 acquires a plurality of point groups. For this reason, the surrounding point group acquisition unit 104 can be implemented by, for example, LIDAR using a wavelength of light. Also for this LiDAR, it is desirable to be highly accurate such that sensing is performed with 32 or more scan lines at 360 degrees in the horizontal direction and about ±20 degrees in the vertical direction.

The position and attitude of the target imaging device 100 can be grasped from information on the position acquisition unit 101 and the azimuth acquisition unit 102. Then, use of these makes it possible to grasp the position of each point group acquired by the surrounding point group acquisition unit 104.

The position acquisition unit 101, the azimuth acquisition unit 102, the image acquisition unit 103, and the surrounding point group acquisition unit 104 may receive information acquired by a position acquisition apparatus, an azimuth acquisition apparatus, an image acquisition apparatus, and a surrounding point group acquisition apparatus each of which is independent, and may perform processing such as data conversion.

Furthermore, the target imaging device 100 has a function of transferring the position, azimuth, image, and three-dimensional point group, which are information acquired by respective units, to the virtual simulation apparatus 200. For this purpose, the target imaging device 100 has a function of installing a storage medium that stores images and the like and an interface function of exchanging images and the like with the virtual simulation apparatus 200.

Next, the virtual simulation apparatus 200 will be described. The virtual simulation apparatus 200 generates and evaluates an inspection plan by using a map based on the information from the target imaging device 100. For this purpose, the virtual simulation apparatus 200 includes a site map generation unit 105, an inspection site DB 106, a travel route generation unit 201, an inspection target setting unit 202, a round plan setting unit 203, a virtual robot operation unit 300, and an inspection information correction unit 400. The virtual simulation apparatus 200 can be implemented by a computer apparatus, and the function of each unit is implemented according to a program. Each component of the virtual simulation apparatus 200 will be described below.

First, the site map generation unit 105 generates a map of the inspection site based on various types of information acquired by the target imaging device 100. That is, information from the target imaging device 100 is converted into a map necessary for autonomous traveling by the autonomous inspection apparatus 600 and a map necessary for inspection, and is stored in the inspection site DB 106. This processing may be performed in real time, or may be performed offline by temporarily writing each piece of information to an external storage apparatus or the like.

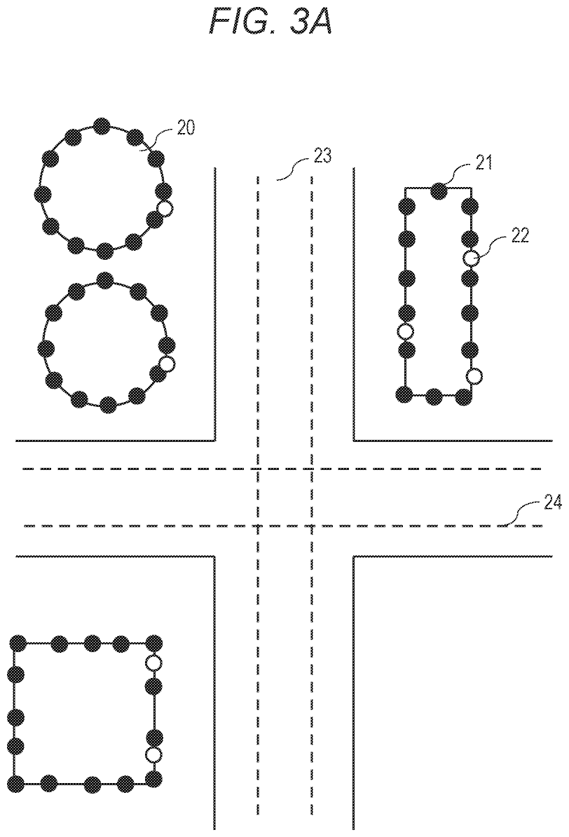

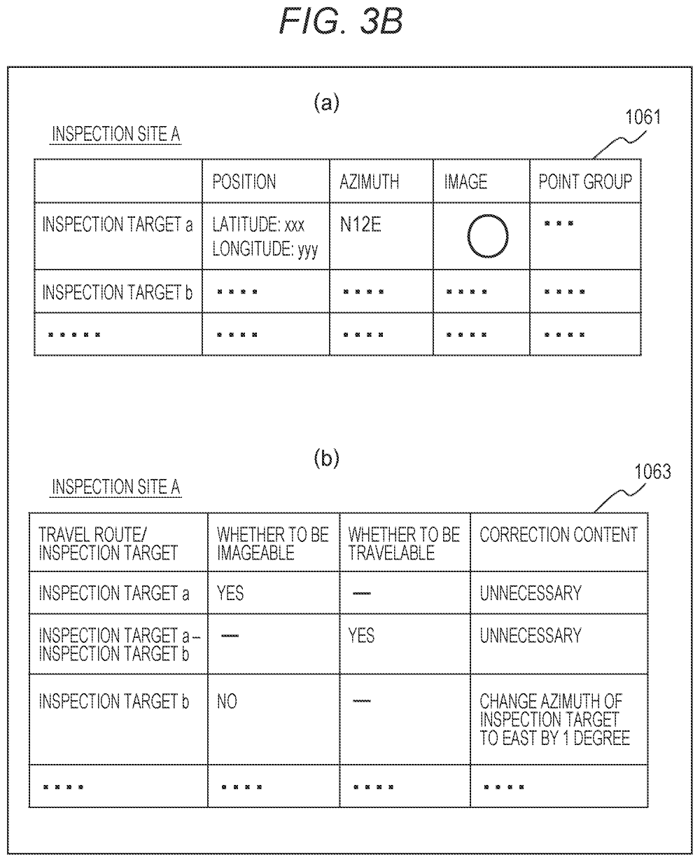

Then, the inspection site DB 106 stores those various types of information and the generated map. Therefore, the inspection site DB 106 can be implemented by a storage apparatus such as a so-called storage. Information stored in the inspection site DB 106 will be described later with reference to FIGS. 3A and 3B.

The travel route generation unit 201 generates a travel route exhaustively including travelable places in the inspection site based on the map of the inspection site DB 106. Here, the travel route is desirably constituted by a node and a link. This travel route may be set while the user is visually checking the travel route, or may be set, as the node and the link, by arranging in time series the positions acquired by the position acquisition unit 101.

Furthermore, the inspection target setting unit 202 specifies the inspection target, particularly its position, based on the map of the inspection site DB 106. Then, it is possible to generate inspection information including the inspection target and travel route having been specified by the travel route generation unit 201 or the inspection target setting unit 202 and indicating the round plan of the autonomous inspection apparatus 600. Here, the inspection target can be set in a form on a list, for example. At this time, the user may register an inspection target 22 while visually checking it, or may register a position separately extracted from an imaging target automatic extraction function or the like.

The round plan setting unit 203 extracts inspection information indicating the round plan from the inspection site DB 106, and outputs the inspection information to the virtual robot operation unit 300 described later. For this purpose, the round plan setting unit 203 specifies the inspection target in response to an input from the user or the like, and extracts inspection information including this.

Generation of the round plan may be executed by the round plan setting unit 203. In this case, the round plan setting unit 203 extracts an inspection target that requires inspection from the inspection site DB 106, and generates and sets, as a round plan, a travel route of the autonomous inspection apparatus 600 based on this. In this case, the travel route may be generated by using a combinatorial optimization problem such as a so-called traveling salesman problem. This inspection information is stored in the inspection site DB 106. In generation of the travel route, it is possible to calculate a normative route by the Dijkstra method or the like based on the position information on the node, the link, and the inspection target stored in the inspection site DB 106.

The virtual robot operation unit 300 performs virtual autonomous traveling and inspection. For this purpose, the virtual robot operation unit 300 causes the autonomous inspection apparatus 600 to virtually inspect and operate according to the generated travel route. At this time, in the virtual operation, not only the autonomous traveling but also an inspection operation of a meter or the like provided in a plant is virtually simulated.

For this purpose, a virtual autonomous travel unit 301 and a virtual autonomous inspection unit 302 are included. Here, by simulation, the virtual autonomous travel unit 301 causes the virtual autonomous inspection apparatus to virtually travel according to the travel route of the inspection information output by the round plan setting unit 203. More specifically, the virtual autonomous travel unit 301 calculates a command value to the autonomous inspection apparatus 600 necessary for operating according to the travel route, and inputs the command value to a robot model of the autonomous inspection apparatus 600. Then, the virtual autonomous travel unit 301 calculates the behavior of the autonomous inspection apparatus 600 according to the robot model, and calculates, from the result, a travel locus indicating the position where the autonomous inspection apparatus 600 moves. The virtual autonomous travel unit 301 performs simulation that simulates autonomous travel by repeating this processing (loop).

The virtual autonomous inspection unit 302 executes the inspection operation on the inspection target of this inspection information by simulation. Therefore, when the virtual autonomous travel unit 301 travels, the virtual autonomous inspection unit 302 desirably performs virtual camera control to image the meter having been set under the simulation environment when reaching the inspection target. Thus, the inspection operation indicates imaging of an inspection target.

As described above, the virtual robot operation unit 300 virtually executes the inspection work by simulation. Then, the virtual robot operation unit 300 evaluates this simulation result. This evaluation indicates a travel status and an inspection status. More preferably, it indicates whether inspection work is possible. More specifically, it indicates whether the autonomous inspection apparatus 600 can travel on the travel route (whether the calculated travel locus maintains the travel route) or can perform inspection. Here, being capable of inspection includes being capable of imaging the meter provided in the inspection information. Then, the virtual robot operation unit 300 outputs this evaluation result to the inspection information correction unit 400 described later. This, the virtual robot operation unit 300 is a type of evaluation unit that evaluates inspection based on the position of the autonomous inspection apparatus 600 in the simulation and the positional relationship among this, the inspection target, and the inspection site.

Next, the inspection information correction unit 400 will be described. The inspection information correction unit 400 corrects the round plan, that is, the inspection information on the target as necessary according to the evaluation result of the virtual robot operation unit 300. For this purpose, the inspection information correction unit 400 includes an inspection route correction unit 401 and an inspection target correction unit 402. First, when the evaluation result of the virtual robot operation unit 300 indicates incapability of travel, the inspection route correction unit 401 corrects the positions of a node and a link on the travel route included in the inspection information.

Based on the evaluation result by the virtual autonomous inspection unit 302, the inspection target correction unit 402 corrects at least one of the position of the inspection target and the position of the autonomous inspection apparatus 600 so that the inspection can be performed.

The evaluation of the virtual robot operation unit 300 may be performed by the inspection information correction unit 400.

Based on the imaged result, for example, the inspection target correction unit 402 outputs the inspection result executed by the virtual autonomous inspection unit 302. Then, the user visually checks this, and if the inspection result is not obtained, at least one of the position of the inspection target and the inspection of the autonomous inspection apparatus 600 is corrected according to the instruction from the user. The case where the inspection result is not obtained includes, for example, a case where the imaged result is deviated.

The description of the function of the inspection support system according to the present example is finished. Then, the hardware configuration of the virtual simulation apparatus 200, which is a type of maintenance support apparatus, will be described.

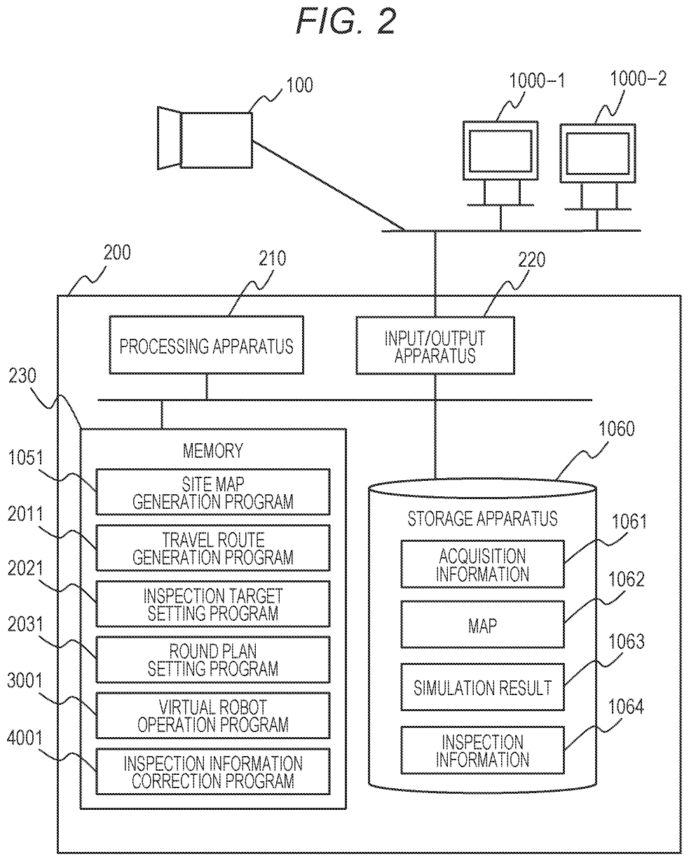

FIG. 2 is the hardware configuration diagram of the virtual simulation apparatus 200 in the present example. As described above, the virtual simulation apparatus 200 can be implemented by a computer apparatus. Therefore, the virtual simulation apparatus 200 includes a processing apparatus 210, an input/output apparatus 220, a memory 230, and a storage apparatus 1060, which are interconnected via a communication path such as a bus.

First, the processing apparatus 210 can be implemented by a processor such as a CPU, and executes calculation of the units described above according to respective programs stored in the storage apparatus 1060 and developed in the memory 230. That is, the processing apparatus 210 executes the functions of the site map generation unit 105, the travel route generation unit 201, the inspection target setting unit 202, the round plan setting unit 203, the virtual robot operation unit 300, and the inspection information correction unit 400 in FIG. 1. The processing apparatus 210 may be implemented by a field-programmable gate array (FPGA) or an application specific integrated circuit (ASIC).

Next, the input/output apparatus 220 has a connection function (interface) with an external apparatus. Specifically, the input/output apparatus 220 is connected to the target imaging device 100 and terminal apparatuses 1000-1 and 1000-2 used by the user. The various types of acquired information are received from the target imaging device 100. Therefore, the input/output apparatus 220 may be implemented as a slot of a storage medium. In the present example, the two terminal apparatuses 1000-1 and 1000-2 are described, but the number is not limited to this. Furthermore, the input/output apparatus 220 is desirably configured to be connectable to the autonomous inspection apparatus 600 not illustrated.

An instruction from the user is received from the terminal apparatuses 1000-1 and 1000-2. Furthermore, an evaluation result, an imaging content, and the like are output to the terminal apparatuses 1000-1 and 1000-2. The terminal apparatuses 1000-1 and 1000-2 can be implemented by a PC, a tablet, a smartphone, or the like. Note that instead of or in addition to the terminal apparatuses 1000-1 and 1000-2, an input apparatus and an output apparatus may be provided in the virtual simulation apparatus 200.

The memory 230 is implemented by a so-called a ROM, a RAM, or the like. Then, the following programs and information to be calculated stored in the storage apparatus 1060 are developed into the memory 230. These programs include a site map generation program 1051, a travel route generation program 2011, an inspection target setting program 2021, a round plan setting program 2031, a virtual robot operation program 3001, and an inspection information correction program 4001. Here, the various programs and the units illustrated in FIG. 1 have the following correspondence relationships. That is, similar calculation is executed.

site map generation unit 105: site map generation program 1051

travel route generation unit 201: travel route generation program 2011

inspection target setting unit 202: inspection target setting program 2021

round plan setting unit 203: round plan setting program 2031

virtual robot operation unit 300: virtual robot operation program 3001

inspection information correction unit 400: inspection information correction program 4001

Therefore, the virtual robot operation program 3001 may be configured as a virtual autonomous travel program and a virtual autonomous inspection program. The inspection information correction program 4001 may be configured as an inspection route correction program and an inspection target correction program.

The storage apparatus 1060 corresponds to the inspection site DB 106 in FIG. 1. That is, the storage apparatus 1060 has a function of storing information and the above-described programs. Specifically, the storage apparatus 1060 stores, as information, acquisition information 1061, a map 1062, a simulation result 1063 including an evaluation result, and inspection information 1064. The storage apparatus 1060 can be implemented by a storage such as a hard disk drive. Alternatively, the storage apparatus 1060 can also be implemented as a storage medium such as a DVD. This is the end of the description of the present example. In the following description, description will be made with reference to each configuration of FIG. 1.

### <Information>

Next, information used in the present example will be described. First, FIG. 3A schematically illustrates the inspection information 1064 stored in the inspection site DB 106. Here, the inspection information 1064 in FIG. 3A is illustrated in a form including the map 1062, but is not limited to this. Note that FIG. 3A schematically illustrates an example in the present example, and actual information is not limited to this form. The inspection information 1064 of the present example includes an object 20, a point group position 21, the inspection target 22, a paved road 23, and a travel route 24.

However, the inspection information 1064 is only required to indicate a round route in inspection by the autonomous inspection apparatus 600, and may include the inspection target 22 and the travel route 24. In the present example, the inspection information 1064 is configured by adding the inspection target 22 and the travel route 24 to the map 1062 generated by the site map generation unit 105.

Here, the object 20 is an object existing in the inspection site, and is equipment itself or a part constituting this. The point group position 21 indicates the point group position acquired by the surrounding point group acquisition unit 104. The paved road 23 indicates a paved road on which the autonomous inspection apparatus 600 can travel. Here, the paved road does not need to be paved, and only needs to allow the autonomous inspection apparatus 600 to travel thereon. A pedestrian, an automobile, and the like can also travel on the paved road 23. In the present example, the map 1062 is configured as described above.

The inspection target 22 indicates an inspection target set by the inspection target setting unit 202 based on the image imaged by the image acquisition unit 103. The travel route 24 indicates a travel route created by the travel route generation unit 201. In the present example, these and the map 1062 constitute the inspection information 1064. The schematic diagram illustrated in FIG. 3A is an excerpt from the whole, and in reality, the inspection information 1064 exhaustively including the map 1062 is generated in the inspection site.

Next, the acquisition information 1061 and the simulation result 1063 will be described with reference to FIG. 3B. The acquisition information 1061 is information acquired by the target imaging device 100, and has a position, an azimuth, an image, and a point group for each inspection target as illustrated in FIG. 3B(a). The position, the azimuth, the image, and the point group are information acquired by the position acquisition unit 101, the azimuth acquisition unit 102, the image acquisition unit 103, and the surrounding point group acquisition unit 104, respectively. As described above, using these pieces of information, the site map generation unit 105 generates the map 1062. The acquisition information 1061 is desirably provided for each inspection site.

The simulation result 1063 is illustrated in FIG. 3B(b). In the present example, whether to be imagable and whether to be travelable, which are evaluation results, are recorded for each travel route (section) and inspection target. That is, the result of the virtual inspection work in the virtual robot operation unit 300 is recorded.

In the present example, the evaluation result is recorded for each travel route (section) and inspection target, but the unit used for recording is not limited to this. It is sufficient that the position on the map 1062 is specified. Furthermore, in the present example, the correction content specified by the inspection information correction unit 400 is also recorded in the simulation result 1063, but these may be managed as separate information. At this time, it is desirable that the travel route (section) such as “inspection target a—inspection target b” be corrected by the inspection route correction unit 401, and the inspection target such as “inspection target a” be corrected by the inspection target correction unit 402. The inspection information correction unit 400 executes correction corresponding to this correction content on the inspection information 1064.

The description of the information on the present example is completed, and the process flow will be described next.

### <Process Flow>

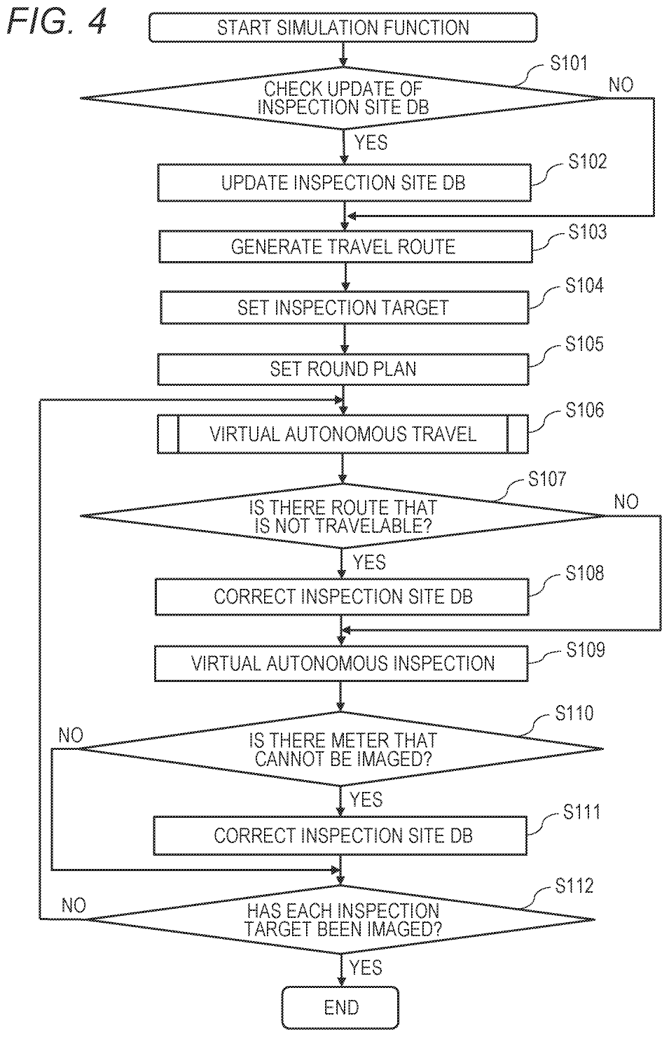

Hereinafter, the process flow of the present example will be described. FIG. 4 is a flowchart illustrating the process flow of the simulation function. The simulation function causes the virtual autonomous inspection apparatus to execute inspection work by simulation and evaluates the inspection work.

First, the travel route generation unit 201 confirms whether the inspection site DB 106 needs to be updated (step S101). For this purpose, the travel route generation unit 201 uses, as a determination reference, whether or not there is the new acquisition information 1061 from the target imaging device 100 or the map 1062 generated by the site map generation unit 105. Here, it is desirable for the travel route generation unit 201 to periodically check the presence or absence of these pieces of the new acquisition information 1061 and the map 1062. As a result, when update is necessary (Y), the process proceeds to step S102. When update is not necessary (N), the process proceeds to step S103.

Next, the travel route generation unit 201 updates the inspection site DB 106 (step S102). In the present example, steps S101 and S102 are performed by the travel route generation unit 201, but may be performed by another configuration. As another configuration, steps S101 and S102 may be performed by a database management unit or the like not illustrated in FIG. 1.

Next, the travel route generation unit 201 generates a travel route (step S103). For this purpose, the travel route generation unit 201 generates a travel route on which the autonomous inspection apparatus travels in the form of nodes and links as described above.

Next, the inspection target setting unit 202 sets an inspection target to be inspected by the autonomous inspection apparatus (step S104). Then, the round plan setting unit 203 outputs, from the inspection site DB 106 to the virtual robot operation unit 300, and sets (step S105) inspection information indicating a round plan including the travel route generated in step S103 and the inspection target set in step S104.

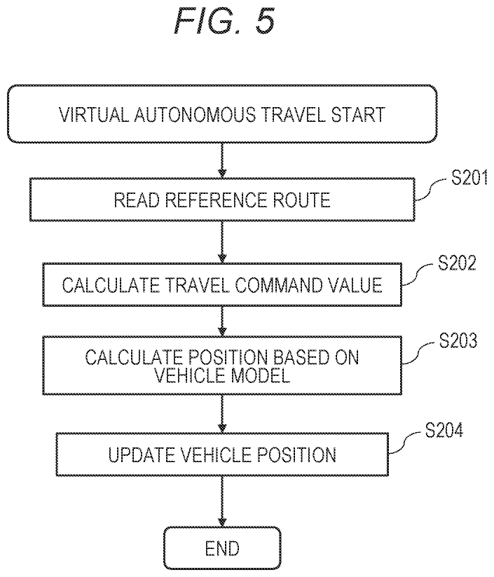

Next, the virtual autonomous travel unit 301 of the virtual robot operation unit 300 virtually travels (step S106) the autonomous inspection apparatus based on the round plan set in step S105. Details of this step will be described later with reference to FIG. 5.

Then, the virtual autonomous travel unit 301 determines (step S107) whether or not there is a travel route (section) that is not travelable in the virtual travel in step S106. That is, the virtual autonomous travel unit 301 evaluates whether traveling included in the inspection work is possible. As a result, if there is a section that is not travelable (Y), the process proceeds to step S108. If there is not any section that is not travelable (N), the process proceeds to step S109. If there is a section that is not travelable, the virtual autonomous travel unit 301 desirably records, according to the evaluation content, the correction content of the simulation result 1063 in the inspection site DB 106.

In step S107, it is desirable to perform evaluation from the positions of the autonomous inspection apparatus and the equipment and the like (the object 20 and the like) in the inspection site and the positional relationship between them. That is, it is possible to evaluate whether the autonomous inspection apparatus and the equipment or the like in the inspection site come into contact with each other.

The inspection route correction unit 401 of the inspection information correction unit 400 corrects (step S108) the travel route evaluated as being not travelable in step S107. At this time, the inspection route correction unit 401 desirably corrects the inspection route according to the correction content of the simulation result 1063.

The virtual autonomous inspection unit 302 detects that while executing step S106, the autonomous inspection apparatus has reached the inspection point where a virtual inspection target is inspected. Then, the virtual autonomous inspection unit 302 performs a virtual inspection on the inspection target (step S109). For example, the virtual autonomous inspection unit 302 executes virtual imaging on the inspection target.

Next, the virtual autonomous inspection unit 302 determines whether or not there is an inspection target that cannot be inspected (step S110). That is, the virtual autonomous inspection unit 302 evaluates whether inspection included in the inspection work is possible. In the present example, imaging is used as inspection, and a meter is used as an inspection target. That is, in this step, whether the meter can be imaged is evaluated. Therefore, in the present example, the autonomous inspection apparatus includes a certain imaging apparatus, but this imaging apparatus may share the target imaging device 100.

As a result of this step, if there is a meter that cannot be imaged (Y), the process proceeds to step S111. If there is not any meter that cannot be imaged (N), the process proceeds to step S112. If there is a meter that cannot be imaged, the virtual autonomous inspection unit 302 desirably records the correction content of the simulation result 1063 in the inspection site DB 106 according to the evaluation content.

Here, a specific example of evaluation in step S110 will be described. The virtual autonomous inspection unit 302 performs image processing on the imaged image data. As a result, when it is determined that characters, needles, and the like of the meter can be read, the virtual autonomous inspection unit 302 evaluates that imaging can be performed. The virtual autonomous inspection unit 302 may be implemented by outputting image data to the terminal apparatuses 1000-1 and 1000-2 and confirming this by the user. That is, confirmation results of the user are received from the terminal apparatuses 1000-1 and 1000-2 of the virtual autonomous inspection unit 302, and are used as the evaluation results.

In this step, together with step S107, whether the inspection work, which is a kind of maintenance work, is possible is evaluated.

Next, the inspection target correction unit 402 of the inspection information correction unit 400 corrects (step S111) the inspection target evaluated as being not imagable in step S110. At this time, the inspection target correction unit 402 desirably performs correction according to the correction content of the simulation result 1063.

The processing of steps S106 to S111 is in no particular order. For example, steps S107 and S109 may be collectively executed, and steps S107, S108, S110, and S111 may be executed thereafter. Steps S107 and S108 and steps S110 and S111 may execute parallel processing.

In the end, the virtual autonomous inspection unit 302 confirms whether or not each inspection target of the round plan has been imaged. As a result, if each inspection target has been imaged (Y), this process flow ends. If each inspection target has not been imaged (N), the process proceeds to step S106, and the process is repeated. The description of the simulation function of the present example is finished, and details of step S106 of this process flow will be described next.

FIG. 5 is a flowchart illustrating details of the process flow of step S106, that is, virtual autonomous travel in the present example.

First of all, the virtual autonomous travel unit 301 reads the travel route (in this flowchart, it is referred to as reference route) of the round plan included in the inspection information 1064 from the inspection site DB 106 (step S201). Next, the virtual autonomous travel unit 301 calculates a travel command value that is a control command value along the reference route (step S202).

Next, the virtual autonomous travel unit 301 provides a preset model with input based on the calculated command value (step S203). Here, as long as the autonomous inspection apparatus uses a steering mechanism, the preset model can be, for example, an Ackermann model or a two-wheel flat model. Furthermore, a differential two-wheel model or the like can be used as long as the autonomous inspection apparatus turns at the rotation speed of the left and right motors.

Next, the virtual autonomous travel unit 301 updates the position of the autonomous inspection apparatus based on the input from the above-described model and the autonomous inspection apparatus (step S204). Here, the parameters in the above-described model are known by analyzing the autonomous inspection apparatus in advance. This is the end of the description of Example 1.

### Example 2

Next, Example 2 will be described. In Example 1, the virtual inspection work is performed by simulation, but in the present example, the autonomous inspection apparatus 600 is experimentally operated to perform the inspection work, and evaluation is performed according to this result. Information of the present example is common to that of Example 1. Therefore, hereinafter, the present example will be described focusing on differences from Example 1 in the order of the configuration and the process flow.

### <Configuration>

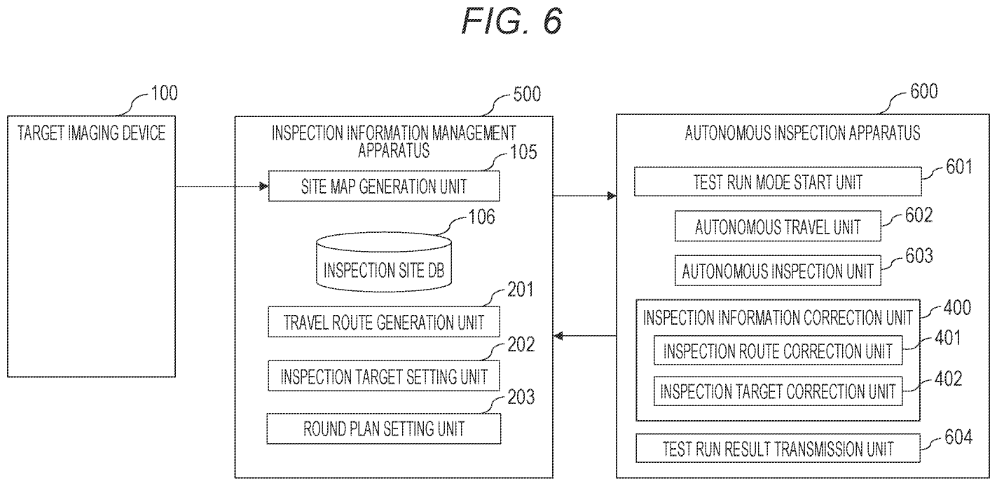

FIG. 6 is a functional block diagram of the target imaging device 100, an inspection information management apparatus 500, and the autonomous inspection apparatus 600 in the present example. As described above, in the present example, evaluation is actually performed using the autonomous inspection apparatus 600 without using simulation. Therefore, in the present example, the inspection information management apparatus 500 and the autonomous inspection apparatus 600 are used instead of the virtual simulation apparatus 200. In the present example, the inspection information management apparatus 500 and the autonomous inspection apparatus 600 are used as an inspection support system that is a type of maintenance support system.

Here, since the target imaging device 100 is common to that of Example 1, the description thereof will be omitted. Next, in the inspection information management apparatus 500, the virtual robot operation unit 300 and the inspection information correction unit 400 are omitted from the virtual simulation apparatus 200 of Example 1. Therefore, the inspection information management apparatus 500 can be implemented in the hardware configuration of the virtual simulation apparatus 200 illustrated in FIG. 2 without the virtual robot operation program 3001 and the inspection information correction program 4001. In the present example, the virtual simulation apparatus 200 may be used instead of the inspection information management apparatus 500.

Here, the inspection information management apparatus 500 includes the site map generation unit 105, the inspection site DB 106, the travel route generation unit 201, the inspection target setting unit 202, and the round plan setting unit 203. Since these have the same functions as those of Example 1, the description thereof will be omitted. The round plan setting unit 203 outputs inspection information indicating a travel route to the autonomous inspection apparatus 600.

The autonomous inspection apparatus 600 is a type of robot, and executes inspection work. The autonomous inspection apparatus 600 includes a test run mode start unit 601, an autonomous travel unit 602, an autonomous inspection unit 603, a test run result transmission unit 604, and the inspection information correction unit 400. Here, since the inspection information correction unit 400 has the same function as that of Example 1, the description thereof will be omitted.

FIG. 6 illustrates only the configuration for information processing, and includes portions for traveling and inspection (imaging). Travel mechanisms such as an actuator and a tire, and inspection mechanisms such as an imaging apparatus are provided.

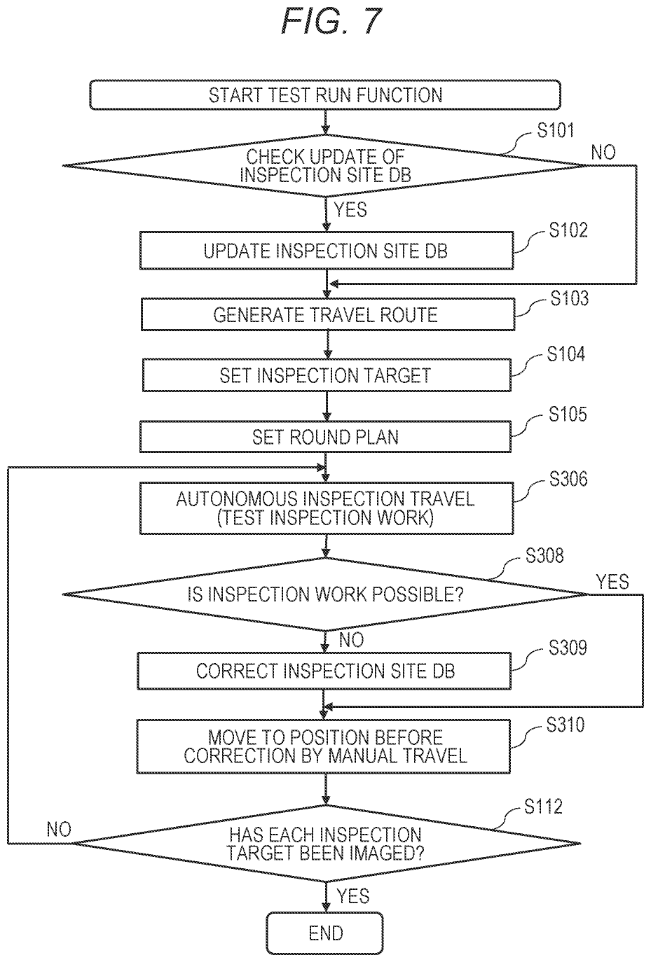

First, the test run mode start unit 601 starts the autonomous inspection apparatus in a test run mode different from the actual inspection mode. It is desirable to use designation from the user or step S105 in FIG. 7 as a condition.

The autonomous travel unit 602 causes the autonomous inspection apparatus 600 to travel in the inspection site according to the travel route of the inspection information output by the round plan setting unit 203. For this purpose, the autonomous travel unit 602 outputs a travel command value to the travel mechanism. As a result, the autonomous inspection apparatus 600 travels using the travel mechanism.

The autonomous inspection unit 603 causes the autonomous inspection apparatus 600 to execute an inspection operation on the inspection target of the inspection information. For this reason, when the autonomous inspection unit 603 reaches the inspection target at the time of travel of the autonomous travel unit 602, the autonomous inspection unit 603 performs camera control on the imaging apparatus such as a camera of the autonomous inspection apparatus 600. Due to this, the camera images the meter to be inspected.

Then, the autonomous travel unit 602 and the autonomous inspection unit 603 evaluate the inspection work similarly to the virtual autonomous travel unit 301 and the virtual autonomous inspection unit 302. That is, the autonomous travel unit 602 evaluates whether the autonomous inspection apparatus 600 can travel on the travel route. The autonomous inspection unit 603 evaluates whether the meter can be read. These evaluations can be implemented by the same processing as in Example 1. In this manner, the autonomous travel unit 602 and the autonomous inspection unit 603 function as evaluation units.

The inspection information correction unit 400 corrects the inspection information 1064 similarly to Example 1. For this purpose, the inspection information correction unit 400 uses the test run result transmission unit 604. That is, the test run result transmission unit 604 transmits a correction instruction including the correction content to the inspection information management apparatus 500. The test run result transmission unit 604 may transmit the evaluation results of the autonomous travel unit 602 and the autonomous inspection unit 603 to the inspection information management apparatus 500. In this case, the inspection information management apparatus 500 desirably corrects the inspection information 1064 using the inspection information correction unit 400 included in itself. The inspection information management apparatus 500 desirably updates the simulation result 1063 based on the information from the test run result transmission unit 604. Thus, in the present example, the inspection site DB 106 can be updated based on the transmission from the test run result transmission unit 604.

The description of the configuration of the present example is completed, and the process flow of the present example will be described next.

### <Process Flow>

Hereinafter, the process flow of the present example will be described. FIG. 7 is a flowchart illustrating the process flow of the test run function. The test run function is to cause the autonomous inspection apparatus 600 to execute inspection work as test run and to evaluate the inspection work. The test run is a convenient expression, and this inspection result may be used.

Processing similar to that in Example 1 is performed from step S101 to step S105. Next, the test run mode start unit 601 starts the test run mode, and according to this, the autonomous inspection apparatus 600 performs the autonomous inspection travel (test inspection work) (step S306). That is, the autonomous travel unit 602 causes the autonomous inspection apparatus 600 to travel in the inspection site according to the travel route of the inspection information output by the round plan setting unit 203. The autonomous inspection unit 603 causes the autonomous inspection apparatus 600 to execute an inspection operation on the inspection target of the inspection information.

Next, the autonomous inspection apparatus 600 evaluates whether the inspection work has been successfully executed (step S308). For this purpose, the autonomous travel unit 602 evaluates whether there is a route (section) that is not travelable during the autonomous inspection travel. The autonomous inspection unit 603 evaluates whether there is a meter that is an inspection target that cannot be imaged. These evaluations can be processed in a similar manner to steps S107 and S110 of Example 1.

As a result, if a route (section) that is not travelable and a meter that is not imagable cannot be found and the inspection work can be performed (Y), the process proceeds to step S310. If there is a route (section) that is not travelable or a meter that is not imagable, and the inspection work cannot be performed (N), the process proceeds to step S309.

Next, the inspection information correction unit 400 corrects (step S309) the content of the inspection site DB 106 according to the evaluation result in step S308. This is similar to step S108 and step S111 of Example 1.

The autonomous travel unit 602 moves the autonomous inspection apparatus 600 to a position where the inspection work cannot be performed according to an instruction from the user input via the terminal apparatuses 1000-1 and 1000-2. Then, when moved to the corresponding position, the autonomous inspection unit 603 performs inspection, that is, imaging of the meter (step S310).

In the end, similarly to Example 1, it is checked whether each inspection target of the round plan has been imaged. As a result, if each inspection target has been imaged (Y), this process flow ends. If each inspection target has not been imaged (N), the process proceeds to step S306, and the process is repeated.

In the present example, the inspection work may be experimentally performed together with the user and the autonomous inspection apparatus 600. In this case, the user brings the target imaging device 100 to image the inspection target. This is the end of the description of the present example.

Each example also includes performing inspection by the autonomous inspection apparatus 600 after the inspection information 1064 is corrected. Furthermore, in each of the above examples, the worker constructs a map necessary for inspection of infrastructure equipment using data acquired using a dedicated device as data necessary for map generation, thereby reducing the cost necessary for transportation and the like of the autonomous inspection apparatus, and moreover, travel evaluation and inspection evaluation are performed using an evaluation function, and a map necessary for the inspection can be corrected based on the route and the inspection result of the autonomous inspection apparatus based on the evaluation result, whereby the introduction cost can be reduced.

The present invention is not limited to each example, and includes various modifications and application examples. For example, the present invention can be applied to maintenance other than inspection and solution of other traveling problems.

What is claimed is:

1. A maintenance support system that supports maintenance using a moving body for equipment, the maintenance support system comprising:
a map generation unit that generates a map of the equipment;
a travel route generation unit that generates a travel route of the moving body for the maintenance;
a maintenance target setting unit that sets a maintenance target of maintenance to be executed along the travel route having been generated;
an evaluation unit that evaluates whether to be capable of maintenance work that follows maintenance information including the travel route and the maintenance target and indicating a round plan of the moving body; and
a maintenance information correction unit that corrects the maintenance information according to a result of the evaluation.

2. The maintenance support system according to claim 1, wherein
the evaluation unit virtually executes a maintenance work that follows the maintenance information by simulation, and evaluates whether the maintenance work is possible according to a result of the simulation.

3. The maintenance support system according to claim 1, wherein
the evaluation unit is provided in the moving body, and
the evaluation unit executes a test maintenance work that follows the maintenance information, and evaluates whether the maintenance work is possible according to a result of the test maintenance work having been executed.

4. The maintenance support system according to claim 1, wherein
the maintenance is inspection of the equipment, and
the evaluation unit evaluates whether the moving body can read a meter provided in the equipment according to the maintenance information.

5. The maintenance support system according to claim 4, wherein
the maintenance is inspection of the equipment, and
the evaluation unit evaluates whether the meter is readable by performing image processing on an image imaged on the meter.

6. The maintenance support system according to claim 1, wherein
the evaluation unit evaluates whether the moving body can travel on the travel route according to the maintenance information.

7. The maintenance support system according to claim 6, wherein
the evaluation unit evaluates whether the moving body can travel on the travel route using a positional relationship between the moving body and the equipment.

8. A maintenance support apparatus that supports maintenance using a moving body for equipment, the maintenance support apparatus comprising:
a map generation unit that generates a map of the equipment;
a travel route generation unit that generates a travel route of the moving body for the maintenance; and
a maintenance target setting unit that sets a maintenance target of maintenance to be executed along the travel route having been generated, wherein
the maintenance support apparatus enables maintenance information to be corrected according to a result of an evaluation as to whether to be capable of maintenance work that follows the maintenance information including the travel route and the maintenance target and indicating a round plan of the moving body.
